(19) United States
(12) Patent Application Publication
(10) Pub. No.: US 2007/0153732 A1
(43) Pub. Date: Jul. 5, 2007

(54) Method for a wireless local area network terminal to access a network, a system and a terminal

(76) Inventor: Zhonghui Yao, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/584,407

(22) Filed: Oct. 20, 2006

(30) Foreign Application Priority Data
Oct. 21, 2005 (CN) 200510100430.1
Oct. 21, 2005 (CN) 200510100693.2

(51) Int. Cl. H04Q 7/00

(52) U.S. Cl. 370/329

(57) ABSTRACT

The present invention discloses a method for a wireless local area network terminal to access a network, a local area network system and a wireless local area network terminal. The wireless local area network includes at least one basic service set and at least one extended service set thereof constructed by a plurality of terminal equipments. In the invention, the extended service set has a uniquely identified extended service set ID, when performing channel scan, the extended service set ID parameter is added; and network selection is performed based on the extended service set ID parameter. Moreover, in the method according to the invention, network sharing may also be performed based on an extended service set.

### FIELD OF THE INVENTION

The present invention relates to wireless local area network technology, in particular, to a method for a wireless local area network terminal to access a network, a local area network system and a wireless local area network terminal.

### BACKGROUND OF THE INVENTION

WLAN (Wireless Local Area Network) technology gains much popularity in the market due to its wirelessness, high-rate access that is comparable to wired access, as well as its low cost. At present, WLAN technology is widely used in homes, schools, hotels, enterprises and the like, and acts as a wireless broadband access technology for providing public wireless broadband data access service.

The basic construction of a WLAN system of the prior art is shown in FIG. 1. In the WLAN system, a wireless local area network 110 includes STAs (Stations) 111, 112 accessed via AP (Access Point) 120, the STAs 111, 112 associated with the same AP 120 construct a Basic Service Set (BSS); a wireless local area network 130 includes STAs 131, 132 accessed via AP 140, the STAs 131, 132 associated with the same AP 140 construct another BSS; a DS (Distribution System) 150 is used for forming a large local area network among different BSSes. In addition, the DS 150 communicates with a Wired local area network 800 via a Portal 810, so that the above large local area network and the Wired local area network 800 form a larger local area network.

The so-called STA refers to a terminal equipment with a wireless local area network interface. At present, many mobile phones in the market can support wireless local area network interfaces, and portable computers are provided with built-in wireless local area network interfaces. For equipments without wireless local area network interfaces, wireless local area network interfaces may be provided by installing a WLAN wireless network card.

In the prior art, Service Set Identification (SSID) is used to identify an Extended Service Set (ESS), that is, when an ESS is constructed by interconnecting BSSes via a DS, the SSID of each AP will be the same with each other. SSID is a character string, mainly for the subscribers to distinguish between different subscriber groups or services on the same AP. SSID has no global encoding method, thus even two completely independent different networks may be configured with the same SSID. Therefore, even if two BSSes are configured with the same SSID, it does not mean that these two BSSes belong to the same ESS.

One drawback of the prior art lies in that because two completely independent different networks may be configured with the same SSID, the SSID can not be credibly used for identifying an ESS. Therefore, STA can not access a wireless local area network based on SSID. In other words, when performing target BSS selection, it can not be determined whether the target BSS belongs to the desired ESS, thus several attempts are needed.

Moreover, when a STA roams from a BSS within an ESS to another BSS, because the SSID can not be credibly used for identifying an ESS, no association can be established between the STA and the ESS substantially. Therefore, roaming across BSSes is equivalent to roaming across two different physical networks, which results in the complexity of reestablishing an association, especially a security association, between the STA and a new BSS, for example, pre-verification or re-verification etc. may be required. Furthermore, in the prior art, when performing target BSS selection before roaming, it can not be determined whether the target BSS belongs to the same ESS as the current BSS.

### SUMMARY OF THE INVENTION

An embodiment of the invention provides a method for a wireless local area network terminal to access a network, a local area network system and a wireless local area network terminal, in which terminal access may be realized based on an extended service set and the number of access attempts may be decreased.

According to one aspect of an embodiment of the invention, there is provided a method for a wireless local area network terminal to access a network, which includes the steps of:
performing channel scan by the terminal and the network side based on a globally unique extended service set ID parameter;
when it is determined according to the extended service set ID parameter that a channel belongs to an extended service set desired to be accessed by the terminal, synchronizing to a corresponding extended service set;
authenticating the terminal and the network side;
associating the terminal with the network side based on the extended service set ID.

According to another aspect of an embodiment of the invention, there is provided a local area network system, which includes a plurality of wireless local area network terminals, the plurality of wireless local area network terminals form at least one basic service set, the basic service sets form at least one extended service set; the at least one extended service set has a globally unique extended service set ID;

the wireless local area network terminals are adapted to perform channel scan with the basic service set based on the extended service set ID; and to determine whether a channel belongs to an extended service set desired to be accessed by the terminals, according to the extended service set ID; and to synchronize to a corresponding extended service set according to the extended service set ID.

According to a further aspect of an embodiment of the invention, there is provided a wireless local area network terminal, which includes:
a channel scan unit, for performing channel scan with a network side based on a globally unique extended service set ID;
a network selecting unit, for determining whether a channel belongs to an extended service set desired to be accessed by the terminal according to the extended service set ID;
an authenticating unit, for performing authentication with the network side; and
an associating unit, for associating with the network side based on the extended service set ID.

In an embodiment of the invention, the identifications of each of terminal equipments and basic service sets in different extended service sets are identified by a globally unique extended service set ID, so that channel scan may be performed based on the globally unique extended service set ID so as to realize a network selection. Therefore, when performing target BSS selection, a target BSS belonging to an ESS desired to be accessed by the STA may be selected, and the number of access attempts may be decreased.

In addition, a terminal may roam rapidly under the same ESS, because in this case no association, especially security association is required to be reestablished with a new BSS.

Moreover, in an embodiment of the invention, network sharing may be performed based on an extended service set. As a result, the network architecture will be much safer and more stable.

### BRIEF DESCRIPTION OF THE DRAWINGS

FIG. 1 is a network architecture diagram of a wireless local area network in the prior art;

FIG. 2 is a network architecture schematic diagram of a wireless local area network according to an embodiment of the invention;

FIG. 3 is a flow chart of a passive scan during channel scan according to an embodiment of the method of the invention;

FIG. 4 is a flow chart of an active scan during channel scan according to an embodiment of the method of the invention;

FIG. 5 is a schematic diagram for negotiating keys in a wireless local area network according to an embodiment of the invention;

FIG. 6 is a schematic diagram showing one embodiment for realizing network sharing based on ESSID according to an embodiment of the invention;

FIG. 7 is a schematic diagram showing another embodiment for realizing network sharing based on ESSID according to an embodiment of the invention;

FIG. 8 is a schematic diagram for supporting logic network sharing based on ESSID according to an embodiment of the invention;

FIG. 9 is a schematic diagram for realizing logic network sharing based on ESSID according to an embodiment of the invention;

FIG. 10 is a schematic diagram for establishing an association between a logic network and an SSID according to an embodiment of the invention; and

FIG. 11 is a block diagram showing one embodiment of a wireless local area network terminal according to an embodiment of the invention.

### DETAILED DESCRIPTION OF THE EMBODIMENTS

In a method for a wireless local area network terminal (i.e. STA) to access a network according to an embodiment of the invention, a globally unique extended service set ID (ESSID) is used to distinguish between extended service sets (ESS), and a STA may perform network access based on ESSID.

In the method according to an embodiment of the invention, to ensure the global uniqueness of an ESSID, a MAC (Media Access Control) address is used to define an ESSID, which identifies an ESS. Since a MAC address has globally unique identifying ability, different ESSes may be uniquely identified by MAC addresses, that is, different ESSes have different ESSIDs.

In the method according to an embodiment of the invention, an ESSID for identifying an ESS may use an Entrance Address intercommunicating the ESS with an external network. When the ESS is in the form of a “isolated Island”, i.e., the ESS does not contact with any external system, its ESSID may be set as a MAC broadcast address. ESSID may also adopt an MAC address of an AP thereof.

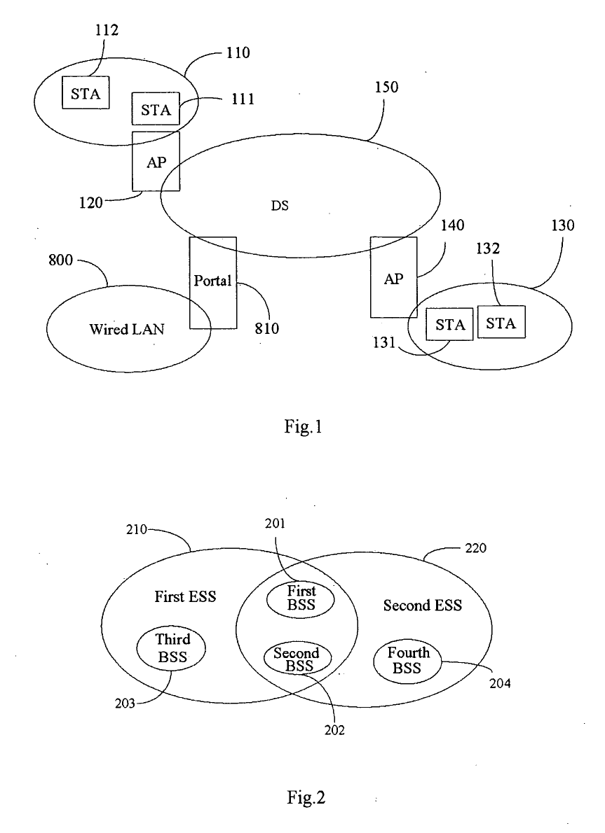

In the method for network access according to an embodiment of the invention, a wireless local area network accessed by a STA may include one or more BSSes, and may include one or more ESSes. One BSS may belong to a plurality of ESSes at the same time. As shown in FIG. 2, the first BSS 201 and the second BSS 202 belong to both the first ESS 210 and the second ESS 220; the first BSS 201, the second BSS 202 and the third BSS 203 all belong to the first ESS 210, while the first BSS 201, the second BSS 202 and the fourth BSS 204 all belong to ESS 220.

The method for network access according to an embodiment of the invention is carried out based on ESSID. During channel scan, the parameter ESSID is added. The channel scan may be a passive scan initiated by a BSS, or it may also be an active scan initiated by a STA.

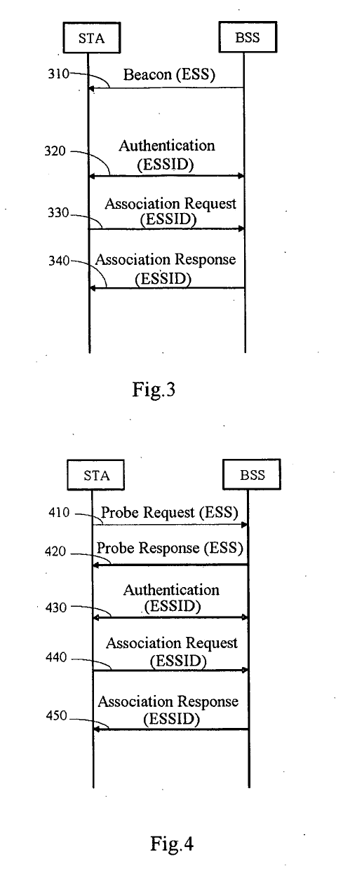

Referring now to FIG. 3, after an extended service set ID ESSID is added in a wireless network, in the method according to an embodiment of the invention, an ESS desired to be accessed by a terminal is selected by employing passive scan.

In step S310, an ESSID parameter is carried in a beacon frame, and a BSS broadcasts the ESSID to which it belongs via this beacon frame.

The ESSID parameter may be carried by adding a corresponding field (such as an ESS field) to the beacon frame. When a BSS belongs to a plurality of ESSes at the same time, this field will contain an ESSID list.

After a STA resolves the beacon frame, it will select a BSS to be accessed according to the ESSID parameter carried therein. For example, only when a corresponding channel belongs to an ESS desired to be accessed by the STA, i.e., it has an expected ESSID, the channel is allowed to be synchronized to the ESS.

In step S320, after an ESSID is determined, an authentication process is carried out. The authentication process may add the ESSID parameter, and thus associate the authentication process with an ESS.

In step S330, after passing the authentication, the STA sends an association request, in which an ESSID parameter may also be carried.

In step S340, the BSS returns an association response, in which an ESSID parameter may also be carried.

Referring now to FIG. 4, after an extended service set ID ESSID is added in a wireless network, in the method according to an embodiment of the invention, an ESS desired to be accessed by a terminal is selected by employing active scan.

Instep S410, a STA sends a probe request frame, in which an ESSID is carried, so as to actively scan a BSS belonging to the corresponding ESS.

An ESSID may be carried by adding a corresponding field (such as an ESS field) in the probe request frame.

The ESSID parameter to be carried in the probe request frame depends on a particular situation. For example, when a STA has known the ESSID of a specific ESS desired to be accessed, the ESSID parameter as carried is set to a specific ESSID. When a STA has not known exactly an ESSID of an ESS desired to be accessed, the ESSID parameter as carried may be set to a MAC broadcast address or null.

When an ESSID parameter is a broadcast address or null, the network selection will depend on other parameters. If the parameter ESSID is a specific ESSID, only when a corresponding channel belongs to the ESS, i.e., it has the same ESSID, the channel is allowed to be synchronized to a corresponding ESS.

In step S420, the BSS returns a probe response frame, in which an ESSID is carried.

Likewise, an ESSID may be carried by adding a corresponding field (such as an ESS field) in the probe response frame.

When no ESSID is carried in the probe request frame or when the ESSID is a broadcast address, the ESSID carried in the probe response frame will be the ESSID to which the BSS belongs; When a BSS belongs to an ESS corresponding to an ESSID carried in the probe request frame, the ESSID carried in the probe response frame will be equal to a corresponding ESSID value in the probe request frame.

In step S430, after an ESSID is determined, an authentication process is carried out. The authentication process may add the ESSID parameter, and thus associate the authentication process with an ESS.

In step S440, after passing the authentication, the STA sends an association request, in which an ESSID parameter may also be carried.

In step S450, the BSS returns an association response, in which an ESSID parameter may also be carried.

The method according to an embodiment of the invention may realize network selection based on ESSID, which is suitable for various cases in which a STA accesses a wireless local area network, for example: the case in which a STA does not know the ESSID of the network, such as the case in which a STA accesses for the first time; the case in which a STA is required to access a specific ESS and knows its ESSID, such as the case in which a STA accesses by roaming, at this point, the STA has accessed a specific ESS, but it is required to roam from the current BSS to another BSS within the ESS.

When the STA has not known exactly an ESSID, the ESSID may be set as a MAC broadcast address or null; otherwise, it may be set as a specific ESSID, i.e., an ESSID to which it belongs. When the parameter ESSID is a broadcast address or null, the network selection will depend on other parameters, for example, a network selection process of the prior art may be employed. If the parameter ESSID is a specific ESSID, only when a corresponding channel belongs to the ESS, i.e., when it has the same ESSID as the STA, the channel is allowed to be synchronized to a corresponding ESS.

After the ESSID is determined, the authentication process and its related processes may add the ESSID parameters, so that the authentication process and its related processes may be associated with the ESS, thus facilitating its authentication. When the ESSID is a broadcast address or null, the related processes described above may be carried out with prior art technology and will not be described in detail herein.

It should be noted that in the processes shown in both FIG. 3 and FIG. 4, the associating step is carried out after an authentication based on extended service set ID has been performed. It will be apparent to those skilled in the art that in order to keep compatibility with the prior art, an open-mode authentication may be performed before the associating step, and the authentication based on extended service set ID may be performed after the associating step.

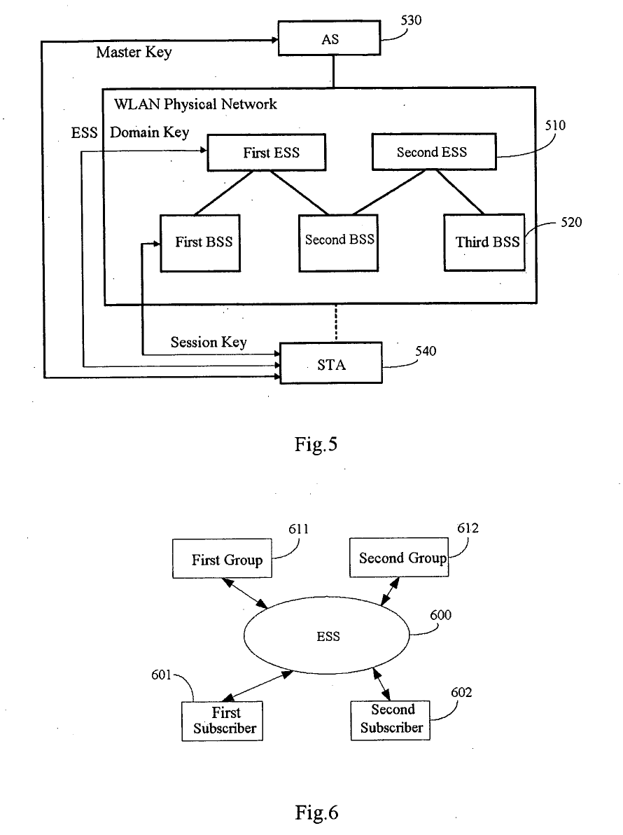

Referring further to FIG. 5, in order to better realize the authentication process of the method according to an embodiment of the invention, an embodiment of the invention provides a novel hierarchical security architecture based on the set ESSID.

The wireless local area network is divided into an ESS layer 510 and a BSS layer 520, wherein BSSes may cross-construct ESSes, an authentication server (AS) 530 is connected to the network, a STA 540 communicates with the BSS layer 520 via a session key PTK and communicates with the ESS layer 510 via an ESS key as well as communicates with the authentication server 530 via a master key respectively.

The authentication process of the method according to an embodiment of the invention includes: performing an identity verification between the STA 540 and the authentication server 530, negotiating a master key MSK and generating a corresponding ESS domain key and BSS domain key (i.e., session key PTK). The session key is generated based on the ESS domain key, while the ESS domain key is generated based on a master key negotiated between the STA 540 and the authentication server 530.

Therefore, when a STA roams between BSSes within an ESS, only the session key is required to be negotiated again based on the ESS domain key, and neither pre-verification nor re-verification is required, so that the steps of roaming process will be reduced and an easy roaming communication will be realized.

Additionally, in the lifetime of a master key, an ESS domain key may be updated periodically; and in the lifetime of an ESS domain key, a session key may be updated periodically. The definitions of session key and master key may be in correspondence with those in the prior art. They differ in that in the prior art, the session key is generated based on the master key, while in the embodiment, the session key is generated based on the ESS domain key.

In the embodiment according to the method, each key represents a trust relationship between two negotiating parts. It should be noted that only a basic architecture is illustrated above, and various modifications may be made as required in the practical application. For example, other connection layers may be added between the authentication server and the hierarchical network.

In the embodiment, network selection and network access is realized based on a globally unique ESSID. Accordingly, network sharing of a wireless local area network may be realized based on the globally unique ESSID.

As used herein, “network sharing” means that different subscriber groups or service groups share a common local area network to carry on corresponding services. For example, in an enterprise network, data service inside the enterprise and visiting Internet accessed by a subscriber may be supported at the same time, and location service, voice service and other data services may be carried on a wireless local area network at the same time etc. As another example, at a wireless local area network hot spot, subscribers of different service providers should be supported to share a common hot spot wireless local area network access.

Referring now to FIG. 6, which is a schematic diagram showing one embodiment for realizing network sharing based on ESSID according to an embodiment of the invention.

The first subscriber 601 or the second subscriber 602 may be associated with a corresponding group, such as the first group 611 or the second group 612, based on an ESS 600, wherein, the group may be a subscriber group or a service group.

When a subscriber requests association, an ESSID parameter and a corresponding group ID (such as a Network Access Identifier NAI) will be carried, and the network side will distinguish between different subscriber groups according to the group ID.

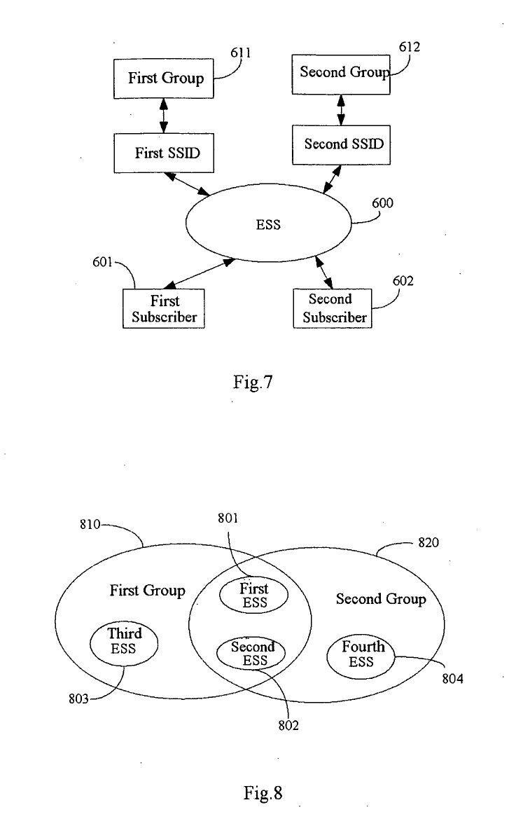

Referring now to FIG. 7, which is a schematic diagram showing another embodiment for realizing network sharing based on ESSID according to an embodiment of the invention.

In this embodiment, a corresponding service set identification SSID is generated for a different group, and one-to-one association is established between groups and SSIDs. The first group 611 corresponds to the first SSID, and the second group 612 corresponds to the second SSID.

When a STA accesses a network, an SSID of a group may also be carried during channel scan to determine whether the ESS has the ability to support this group.

During active scan, an SSID of a group may be carried by employing a probe frame; During passive scan, an SSID of a group may be carried by employing a beacon frame.

It should be noted that, in the embodiment, one ESS may support different groups, and different groups may be accessed from different ESSes. As shown in FIG. 8, the first ESS 801 and the second ESS 802 support both the first group 810 and the second group 802; the first ESS 801, the second ESS 802 and the third ESS 803 may support the first group 810, the first ESS 801, the second ESS 802 and the fourth ESS 804, and support the second group 820 at the same time.

In the embodiment according to the method, the physical network of one wireless local area network may contain only one BSS, or it may contain a plurality of BSSes; and it may contain only one ESS or a plurality of ESSes. Different subscriber groups or service groups may correspond to different logic networks, which are carried on a physical network. Different logic networks may be mapped to different physical networks respectively, or may be mapped to the same physical network. As a result, the network may be reorganized based on its functions and uses.

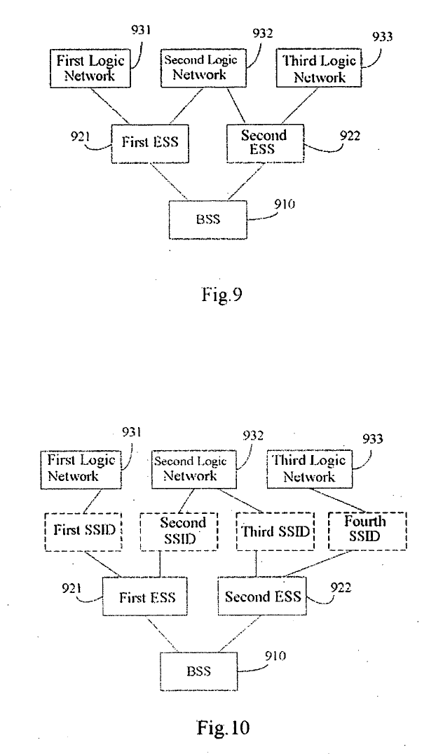

Referring now to FIG. 9, BSS 910 is shared by the first ESS 921 and the second ESS 922, the first ESS 921 is shared by the first logic network 931 and the second logic network 932, and the second ESS 922 is shared by the second logic network 932 and the third logic network 933. The identification of BSS is BSSID, the identification of ESS is ESSID, and the identification of logic network is LNIID. The logic network identification LNIID may employ a global network access identifier NAI.

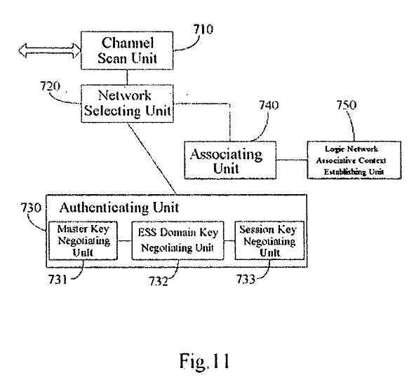

In order to keep compatibility, different logic networks on the same ESS may be distinguished via SSIDs, and one-to-one association between the logic networks and the SSIDs may be established on the ESS. As shown in FIG. 10, the first SSID is assigned to the first logic network 931; the second SSID and the third SSID are assigned to the second logic network 932; and the fourth SSID is assigned to the third logic network 933.

When a STA is accessed via a selected wireless local area network, a corresponding logic network associative context will be established on the network side and the STA side to represent a corresponding network selection relationship, i.e., the logic network association between the network side and the STA side, that is, to which extended service set the STA is associated. The context contains the following information:

1) Access Path Information

Access path information includes: a terminal MAC address, BSSID, ESSID and SSID. SSID is optional, and SSID is reserved so as to keep compatibility with a multi-SSID solution of the prior art. ESSID specifies an ESS selected by a subscriber. BSSID specifies a BSS that support the subscriber to access an ESS.

2) Optional Subscriber Authorization Information Related to the Association

ESS and BSS should exert a corresponding access control, such as security, QoS and billing, on the subscriber based on the authorization information, in their corresponding scopes. The information may be issued to the wireless local area network, only after a verification server of a corresponding logic network completes access verification on the subscriber.

In a wireless local area network, the access path of a STA may be changed. For example, it can be switched from a BSS to another BSS within an ESS, i.e., BSSID alteration; it can be switched from an ESS to another ESS with keeping its BSS unchanged, i.e., ESSID alteration; or it can be switched from a BSS of an ESS to another BSS of another ESS, i.e., ESSID and BSSID alteration.

For BSSID alteration, the logic network associative context should be updated to reflect the change of BSS. At the same time, a corresponding mechanism, such as security, QoS (Quality of Service), should be reestablished in a corresponding BSS to meet the requirements of the subscriber service, and neither pre-verification nor re-verification is required. At this point, the ESSID is not changed.

For ESS alteration (regardless of BSS alteration), a subscriber is required to perform the first access re-verification or pre-verification, so that a new logic network associative context may be established.

Since a plurality of ESSes may share a common BSS, a plurality of logic networks may share a common ESS, and network sharing is established at ESS layer, rather than at BSS layer, the BSS alteration within one ESS will not require re-verification or pre-verification to establish a new logic network associative context, because no change is made in the association between the ESS and the logic network. As a result, the network architecture will be much safer and more stable.

Referring now to FIG. 11, which shows one embodiment of a wireless local area network terminal according to an embodiment of the invention, including: a channel scan unit 710, for performing channel scan with a network side based on a globally unique extended service set ID; a network selecting unit 720, for determining whether a channel belongs to an extended service set desired to be accessed by the terminal according to the extended service set ID; an authenticating unit 730, for performing authentication with the network side; and an associating unit 740, for associating with the network side based on the extended service set ID.

In one embodiment of the invention, when passive scan is employed, the channel scan unit 710 includes a beacon frame resolving unit, for resolving a beacon frame by which the network side broadcasts an extended service set ID of an extended service set to which a basic service set belongs.

In one embodiment of the invention, the channel scan unit 720 includes: a request frame sending unit, for sending a request frame of channel scan; a reply frame resolving unit, for resolving a reply frame of channel scan from the network side.

When an extended service set ID parameter is carried in the request frame, the reply frame may carry the extended service set ID. When the request frame carries an extended service set ID which is a media access control broadcast address or null, the reply frame may carry an extended service set ID to which the basic service set belongs.

In one embodiment of the invention, based on the above hierarchical security architecture, the wireless local area network terminal authenticating unit 730 may also include: a master key negotiating unit 731, for performing identity verification with an authentication server and negotiating a master key; an extended service set domain key negotiating unit 732, for generating an extended service set domain key between the terminal and extended service set according to the master key; an session key negotiating unit 733, for generating a session key between the terminal and basic service set according to the extended service set domain key.

Moreover, on a basis of the realization of logic network sharing based on an extended service set ID, a logic network associative context establishing unit 750 of the wireless local area network terminal according to the embodiment is provided for establishing a logic network associative context representing a network selection relationship at the terminal and the network side. The logic network associative context at least includes: a media access control address of the terminal, a basic service set ID and the globally unique extended service set ID.

It should be understood that the above detailed description of the particular embodiments is only illustrative of the present invention and should not be construed as limiting the scope of the invention which is defined by the appended claims.

1. A method for a wireless local area network terminal to access a network, comprising the steps of:
performing channel scan by said terminal and said network side based on a globally unique extended service set ID parameter;
when it is determined according to said extended service set ID parameter that a channel belongs to an extended service set desired to be accessed by said terminal, synchronizing to a corresponding extended service set;
authenticating said terminal and said network side;
associating said terminal with said network side based on said extended service set ID.

2. The method according to claim 1, wherein said step of performing channel scan comprises: broadcasting an extended service set ID of an extended service set to which a basic service set belongs, by said network side via a beacon frame.

3. The method according to claim 1, wherein said step of performing channel scan comprises: carrying an extended service set ID parameter in a request frame of channel scan by said terminal; and when a basic service set of said network side belongs to an extended service set corresponding to the extended service set ID carried in said request frame, carrying said extended service set ID in a reply frame of channel scan by said network side.

4. The method according to claim 1, wherein said step of performing channel scan comprises: carrying an extended service set ID parameter which is a media access control broadcast address or null in a request frame of channel scan by said terminal; and carrying an extended service set ID to which a basic service set belongs, in a reply frame of channel scan by said network side.

5. The method according to claim 1, wherein said extended service set ID is a media access control broadcast address of a corresponding extended service set, or an entrance address for intercommunicating a corresponding extended service set with an external network.

6. The method according to claim 1, wherein after associating said terminal with said network side based on said extended service set ID, said method further comprises:
performing identity verification between said terminal and an authentication server and negotiating a master key;
generating an extended service set domain key between said terminal and said extended service set according to said master key; and
generating a session key between said terminal and said basic service set according to said extended service set domain key.

7. The method according to claim 6, further comprising:
associating said terminal with said network side based on said extended service set ID, when said terminal switches between different basic service sets of a same extended service set; and
generating a session key between said terminal and said basic service set according to said extended service set domain key.

8. The method according to claim 1, wherein said step of authenticating said terminal and said network side is performed based on said extended service set ID.

9. The method according to claim 1, wherein said step of associating said terminal with said network side based on said extended service set ID comprises: carrying a logic network ID of the shared extended service set desired to be accessed by said terminal in an association request; and associating said terminal with a logic network corresponding to said logic network ID, when said network side determines that it supports said logic network;
said method further comprises: establishing a corresponding logic network associative context on said network side and terminal side.

10. The method according to claim 9, wherein said logic network associative context includes: access path information and optional subscriber authorization information related to said association; said access path information includes: a media access control address of a terminal equipment, a basic service set ID and an extended service set ID.

11. The method according to claim 1, wherein before said step of associating said terminal with said network side based on said extended service set ID, said method further comprises: during channel scan, determining whether said extended service set of said network side supports a logic network desired to be accessed by said terminal based on a service set identification assigned to said logic network;
said method further comprises: establishing a corresponding logic network associative context on said network side and terminal side.

12. The method according to claim 11, wherein said logic network associative context includes: access path information and optional subscriber authorization information related to said association; said access path information includes: a media access control address of a terminal equipment, a basic service set ID, an extended service set ID and a service set identification of a logic network.

13. The method according to claim 10, wherein said subscriber authorization information is issued to a network after a verification server of a corresponding logic network completes subscriber access verification, said subscriber authorization information comprises information by which the extended service set and the basic service set exert a corresponding access control, such as security, QoS and billing, on said subscriber in a corresponding scope thereof.

14. The method according to claim 9, further comprising: when said terminal switches from a basic service set to another basic service set in an extended service set, updating the basic service set ID in said logic network associative context and reestablishing a security, QoS mechanism in said another basic service set.

15. The method according to claim 9, further comprising: newly establishing a logic network associative context when said terminal switches from an extended service set to another extended service set with its basic service set keeping unchanged or switches from a basic service set of an extended service set to another basic service set of another extended service set.

16. A local area network system, which comprises a plurality of wireless local area network terminals, said plurality of wireless local area network terminals form at least one basic service set, and said basic service sets form at least one extended service set; wherein
said at least one extended service set has a globally unique extended service set ID;
said wireless local area network terminals are adapted to perform channel scan with said basic service set based on said extended service set ID; and to determine whether a channel belongs to an extended service set desired to be accessed by said terminals, according to said extended service set ID; and to synchronize to a corresponding extended service set according to said extended service set ID.

17. The local area network system according to claim 16, wherein: one basic service set belongs to a plurality of extended service sets; and one extended service set includes a plurality of basic service sets.

18. The local area network system according to claim 16, wherein said extended service set ID is a media access control broadcast address of a corresponding extended service set, or an entrance address for intercommunicating a corresponding extended service set with an external network.

19. The local area network system according to claim 16, further comprising an authentication server for performing identity verification with said wireless local area network terminals and negotiating a master key;
wherein said master key acts as a basis for generating an extended service set domain key between said terminal and said extended service set; and said extended service set domain key acts as a basis for generating a session key between said terminal and said basic service set.

20. The local area network system according to claim 16, wherein said extended service set corresponds to at least one logic network.

21. A wireless local area network terminal, which comprises:
a channel scan unit, for performing channel scan with a network side based on a globally unique extended service set ID;
a network selecting unit, for determining whether a channel belongs to an extended service set desired to be accessed by said terminal according to said extended service set ID;
an authenticating unit, for performing authentication with said network side; and
an associating unit, for associating with said network side based on said extended service set ID.

22. The wireless local area network terminal according to claim 21, wherein said channel scan unit comprises a beacon frame resolving unit for resolving a beacon frame by which said network side broadcasts an extended service set ID of an extended service set to which a basic service set belongs.

23. The wireless local area network terminal according to claim 21, wherein said channel scan unit comprises: a request frame sending unit, for sending a request frame of channel scan in which an extended service set ID is carried; a reply frame resolving unit, for resolving a reply frame of channel scan in which said extended service set ID is carried by a network side.

24. The wireless local area network terminal according to claim 21, wherein said channel scan unit comprises: a request frame sending unit, for sending a request frame of channel scan, said request frame carrying an extended service set ID which is a media access control broadcast address or null; a reply frame resolving unit, for resolving a reply frame of channel scan in which an extended service set ID to which a basic service set belongs is carried by said network side.

25. The wireless local area network terminal according to claim 21, wherein said authenticating unit further comprises:
a master key negotiating unit, for performing identity verification with an authentication server and negotiating a master key;
an extended service set domain key negotiating unit, for generating an extended service set domain key between said terminal and said extended service set according to said master key; and
a session key negotiating unit, for generating a session key between said terminal and said basic service set according to said extended service set domain key.

26. The wireless local area network terminal according to claim 21, further comprising: a logic network associative context establishing unit, for establishing a logic network associative context representing a network selection relationship at said terminal and said network side; wherein, said logic network associative context at least includes: a media access control address of a terminal, a basic service set ID and said globally unique extended service set ID.
